(19) United States
(12) Patent Application Publication
(10) Pub. No.: US 2012/0231215 A1
(43) Pub. Date: Sep. 13, 2012

(54) VEHICLE DOOR TRIM PANEL AND METHOD FOR MANUFACTURING THE SAME

(75) Inventor: Ken-ichi Hayashi, Aichi (JP)

(73) Assignee: HAYASHI ENGINEERING INC., Nagoya (JP)

(21) Appl. No.: 13/415,738

(22) Filed: Mar. 8, 2012

(30) Foreign Application Priority Data
Mar. 10, 2011 (JP) 2011-053008

(51) Int. Cl. B60R 13/02; B32B 3/02; B32B 3/24; B29C 71/00

(52) U.S. Cl. 428/138; 156/64; 428/192

(57) ABSTRACT

A vehicle door trim panel has a resin core. The resin core has a foam layer and a skin layer that covers the foam layer. The skin layer is harder and thinner than the foam layer. A tape member is applied to the resin core along at least a part of an outer edge of the resin core or along at least a part of a peripheral edge of an aperture of the resin core.

The present application is based on, and claims priority from, JP Application No. 2011-53008, filed on Mar. 10, 2011, the disclosure of which is hereby incorporated by reference herein in its entirety.

### BACKGROUND OF THE INVENTION

1. Field of the Invention

The present invention relates to a vehicle door trim panel which is mounted on a door panel of a vehicle from inside the vehicle. The present invention also relates to a method for manufacturing the vehicle door trim panel.

2. Description of the Related Art

A vehicle door trim panel which is mounted on a door panel from inside the vehicle provides various functions for passengers and gives ornamental features to the vehicle compartment. Side impact loads are mainly absorbed by the door panel and in order to prevent injuries to passengers, a need has developed for a vehicle door trim panel in which there will be no occurrence of cracks or sharp edges, that are caused by cracking, on the interior surface of the vehicle door trim panel.

JP11-147233A discloses a vehicle door trim panel which is made of a resin core molded in a desired curved shape. The resin core has a high impact-resistive core material that contains a rubber component. The core material is located in the impact area which is positioned at the side of a passenger. Because a ductile fracture, which occurs when an impact load is applied, is a feature of the high impact-resistive core material, this material has improved impact-resistive capability and therefore there is reduced likelihood that sharp edges will occur in the resin core.

JP2003-231445A discloses a vehicle door trim panel in which the impact area is made of a high impact-resistive core formed from a non-foam layer and in which the non-impact area is partially made of a foam layer. The foam layer achieves weight reduction while preventing the occurrence of sharp edges in the resin core.

JP2007-253844A discloses a vehicle door trim panel in which a foam layer is used not only in the non-impact area but also in the impact area. The foam layer is covered with a skin layer, which is a hard-cured non-foam layer formed in a thin film. In the example, the skin layer has a larger thickness in the impact area than in the non-impact area, with the result that there is reduced likelihood that cracks and sharp edges will occur in the resin core in the impact area when an impact load is applied, and also with the result that further weight reduction will be achieved.

The vehicle door trim panel described in JP11-147233A is advantageous in terms of impact-resistive capability, but is disadvantageous in terms of weight reduction because the entire resin core is made of a solid non-foam layer. The vehicle door trim panel disclosed in JP2003-231445A has a foam layer provided in the non-impact area, but is not satisfactory in terms of weight reduction because the impact area which occupies a large area in the resin core is made of a solid non-foam layer. Therefore, it is desirable that the entire portion, including the impact area, be made of a foam layer and a skin layer, as described in JP2007-253844A. However, the vehicle door trim panel described in JP2007-253844A requires complicated molding steps for the resin core and a high cost due to the configuration of the skin layer in which the thickness gradually changes. Furthermore, the skin layer has a relatively large thickness in the impact area, which results in a low expansion ratio of the foam layer and insufficient weight reduction.

### SUMMARY OF THE INVENTION

The present invention aims at providing a light weight and low-cost vehicle door trim panel in which there is reduced possibility for cracks and sharp edges to occur in the resin core when an impact load is applied to the side surface of the vehicle, and also aims at providing a method for manufacturing such a vehicle door trim panel.

According to an embodiment of the present invention, a vehicle door trim panel comprises a resin core. The resin core comprises a foam layer and a skin layer that covers the foam layer. The skin layer is harder and thinner than the foam layer. A tape member is applied to the resin core along at least a part of an outer edge of the resin core or along at least a part of a peripheral edge of an aperture of the resin core.

Cracks of the resin core are generated at the outer edge of the resin core or at the peripheral edge of an aperture, if such an aperture is present, and propagate from the crack initiating point. The force applied to the outer edge or the peripheral edge is considered to be of the type that tears the resin core along the outer edge or the peripheral edge. In the present invention, the tape member is applied along the outer edge or the peripheral edge, i.e., applied in the same direction as the tearing force, and hence it is possible to effectively prevent the generation and propagation of cracks. Therefore, it is also possible to prevent the generation of sharp edges caused by the cracks. In addition, the vehicle door trim panel has only a small amount of weight increase and is low-cost because the tape member is used for reinforcement.

According to the present invention, it is possible to provide a light weight and low-cost vehicle door trim panel in which there is reduced possibility for cracks and sharp edges to occur in the resin core when an impact load is applied to the side surface of the vehicle, and also to provide a method for manufacturing the vehicle door trim panel.

The above and other objects, features and advantages of the present invention will become apparent from the following description with reference to the accompanying drawings which illustrate examples of the present invention.

### BRIEF DESCRIPTION OF THE DRAWINGS

FIG. 1 is a general schematic view of the front door trim panel according to an embodiment of the present invention, as viewed from the vehicle compartment;

FIG. 2 is an exemplary partial sectional view of the resin core;

FIG. 3 is a schematic representation of side impact testing on a front door;

FIG. 4 is a general schematic view of the trim lower member of the front door trim panel of FIG. 1, as viewed from outside the vehicle;

FIGS. 5A and 5B are partially enlarged views showing the crack initiation point and the tape member;

FIG. 6 is a view showing the trim lower member of FIG. 4 and preferable locations for applying the tape members; and

FIG. 7 is a view showing the rear door trim panel and preferable locations for applying the tape members.

### DETAILED DESCRIPTION OF THE PREFERRED EMBODIMENTS

Referring to the drawings, embodiments of the vehicle door trim panel of the present invention will be described below.

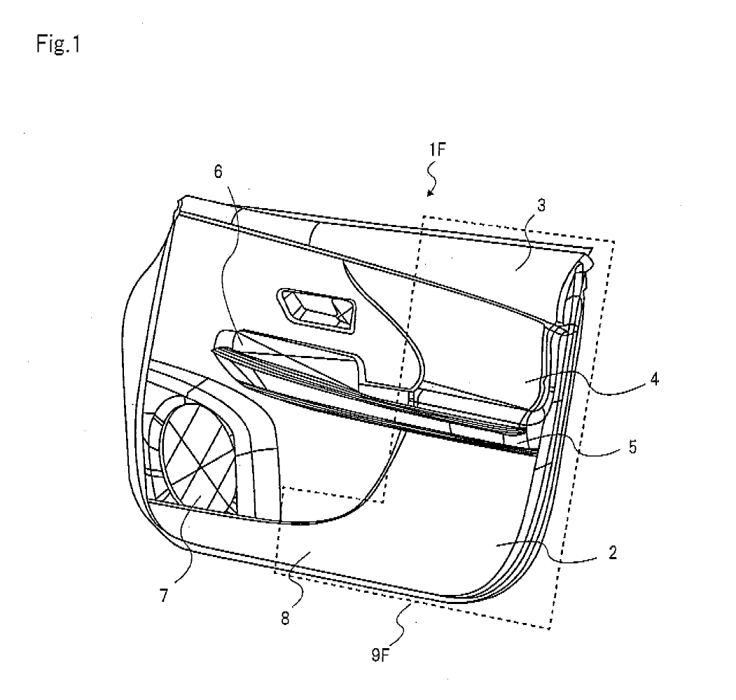

FIG. 1 is a general schematic view of the front door trim panel according to an embodiment of the present invention, as viewed from the vehicle compartment. FIG. 1 shows an example of the front door trim panel. Front door trim panel 1F according to the embodiment is generally composed of three separate parts, i.e., trim lower member 2, trim upper member 3 and ornament 4. The vehicle door trim panel of the present invention is not limited to a structure of three separate parts, but may be formed as a one-piece structure or as a two-piece structure. These members are formed in desired curved shapes and are attached to the door inner panel (not shown) from the compartment side by means of mounting means, such as clips (not shown). Arm rest 5, pull handle 6, speaker grill 7, door pocket 8 etc. are formed on trim lower member 2 which occupies the greater portion of front door trim panel 1F. These elements may have partial apertures, and separate parts, such as a switch, a change box, a cover and a lid may be attached to the apertures.

A vehicle door trim panel generally requires appropriate stiffness so that it will be sufficiently strong when it is mounted to the door inner panel and to ensure that its function, as an interior member, can be implemented. For this reason, the members constituting the vehicle door trim panel, i.e., trim lower member 2, trim upper member 3 and ornament 4 are formed from a resin core. In other words, the vehicle door trim panel includes one resin core or a plurality of resin cores which are combined with each other. The resin core provides appropriate stiffness at a low cost.

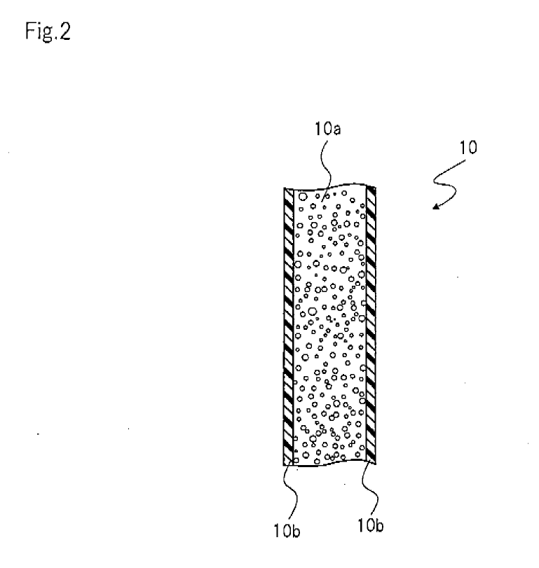

FIG. 2 shows a sectional view of the resin core. Resin core 10 has foam layer 10a and skin layer 10b that is harder than foam layer 10a. Skin layer 10b is formed thinner than foam layer 10a and covers foam layer 10a. More specifically, a majority of resin core 10 is composed of foam layer 10a and the outer surface of foam layer 10a is covered with skin layer 10b that is made from a non-foam layer. The hardness of foam layer 10a and skin layer 10b may be defined according to Rockwell hardness, for example, in accordance with JIS K7202.

In order to mold such resin core 10, the upper half and lower half of a molding die are clamped together first to form a cavity. Then, molten resin containing a foaming agent is poured into the cavity in order to shape the original form of resin core 10. After that, the molding die is half-opened by raising the upper half with regard to the lower half by a predetermined distance so that the foaming action of the foaming agent filled in the molten resin will occur more easily. When the molten resin is poured into the cavity formed by the firmly clamped molding die, the poured molten resin is rapidly cooled by coming into contact with the molding surface of the cavity and solidifies before the foaming action of the foaming agent starts. As a result, a hard-cured non-foam layer in the form of a thin film, i.e., skin layer 10b, is formed in the outer portion of foam layer 10a, and resin core 10 shown in FIG. 2 is formed.

Resin core 10 molded in this manner has, throughout almost the entire portion, a structure in which inner foam layer 10a is formed inside, and the outer surface of foam layer 10a is covered with skin layer 10b composed of a non-foam layer. Therefore, it is possible to achieve substantial weight reduction and to ensure appropriate stiffness compared to a conventional vehicle door trim panel in which the resin core is entirely or only partially composed of a solid non-foam layer.

Thermoplastic resins (one of synthetic resins) are preferably used as the material for resin core 10 because they have good molding properties and because they have good shape retaining properties after molding has been carried out. Modified resins that have more elastomer-like properties, obtained by adding soft components such as rubber components to a synthetic resin, may be also used. Examples of thermoplastic resins include an olefin-based resin and an olefin-based thermoplastic elastomer. A homopolymer, a copolymer obtained by copolymerizing two or more monomers, a copolymer obtained by copolymerizing olefin and unsaturated carboxylic acid and combinations thereof may also be used. Specifically, polypropylene, polyethylene, acrylonitrile-butadiene styrene resin (ABS resin), polyethylene terephthalate (PET), polyamide, polystyrene and combinations thereof may be used. Modified resins obtained by adding rubber components to these resins may also be used. In this case, the modified resin preferably contains 10 to 50 weight percents of the rubber components. The material obtained with this weight percent range is suitable for molding a generally thin door trim panel (the thickness of the main portion is about 3 mm) with a large expansion ratio of not less than 1.6 and not more than 2.4, and thereby it is possible to achieve further weight reduction. The modification effect by the rubber components (an increase in impact strength) may be insufficient for a weight percent of less than 10%. if the weight percent exceeds 50%, then the stiffness required for the vehicle door trim panel may be insufficient and a large expansion ratio may not be obtained due to poor foaming action of the resin. Melting point of the resin materials that are meltable, for example, in the range of 100° C. to 300° C. When molding a vehicle door trim panel having a large area and a small thickness, a resin having a large melt index (Ml) [for example, not less than 50 g/min] may be preferably used in order to allow resin material to flow smoothly in the cavity formed by the molding die.

The foaming agent contained in resin core 10 may be inert gases present in the gas phase at a normal temperature and under 1 atm (1013 hectopascals), physical foaming agents such as a volatile organic compound, chemical foaming agents which generate gas when decomposed or when reacting with heat, and combinations thereof. The inert gas may be carbon dioxide, nitrogen, argon, helium, neon, and combinations thereof. The volatile organic compound may be a volatile foaming agent which generates hydrocarbon, such as butane and pentane. The chemical foaming agent may be an inorganic foaming agent which generates carbon acid gas, such as ammonium carbonate and sodium hydrocarbonate, and an organic foaming agent which generates organic compound gas, such as polycarboxylic acid and azo compound.

Resin core 10 may be fabricated using only resin and a foaming agent, but an additive may be contained in resin core 10. The additive may be a filling material such as talc, a nucleation agent, a pigment, a lubricant, an oxidation inhibitor, a heat stabilizer, an ultraviolet absorber, an antistatic agent and combinations thereof.

In a vehicle door trim panel, the area that extends substantially along a passenger sitting in a vehicle is considered as the impact area (which is impact area gF in the case of the front door trim panel). As indicated by the broken line in FIG. 1, the impact area is an area with which the passenger's body is apt to abut when an impact load is applied to the vehicle from outside thereof. Impact area 9F, if the area is thought to be wide, corresponds to the rear half of the vehicle door trim panel, seen in the travel direction of the vehicle, and the lower half of the vehicle door trim panel. Impact area 9F is required, as a matter of course, not to give excessive impact to the passenger's body and, in addition, to prevent the formation of cracks in resin core 10 and sharp edges caused by the cracks. The cracks and sharp edges give the passenger a sense of danger.

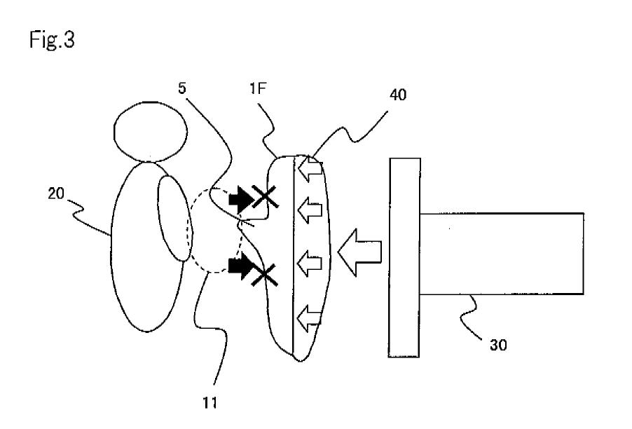

As an impact-resistive capability test in Japan related to a vehicle door trim panel, side impact testing carried out by NASVA (National Agency for Automotive Safety & Victim's Aid) as part of the automobile assessment program called JNCAP (Japan New Car Assessment Program) is known. FIG. 3 schematically illustrates the side impact test for a front door. In this test, dummy 20 called “Euro SID-2” that simulates a grownup male (about 170 cm tall and about 72 kg in weight) is prepared, and dummy 20 is placed on the driver's seat of a stationary test car. Then, carriage 30 having a mass of 950 kg is forced to collide against the side surface of the test car at 55 km per hour from the driver's seat side. Side air bag 11, if mounted, will be operated. The passenger protecting function is evaluated based on the impact that the dummy 20 receives on the head, chest, abdomen and lower back. Currently, such testing is required to ensure passenger's safety.

The inventors of the present application carried out such tests, as well as equivalent tests for parts of the door trim panel, and found that high impact-resistive capability and tensile properties having large tensile elongation are important as necessary mechanical properties, from among other kinds of properties, for comprising a material used in a resin core that constitutes a vehicle door trim panel.

FIG. 3 shows the load applied to front door trim panel 1F in a side crash in the above-described side impact testing. The load generated by the deformation of door panel 40 is inputted from the outside of front door trim panel 1F, and reactive force from dummy 20 or side air bag 11 is inputted from the inside. Cracks and sharp edges are believed to be generated due to the action of both loads mentioned above which differ in direction and mode. Specifically, impact-resistive capability is important for the load from the passenger or the side air bag, which is a load usually expected in a crash. On the other hand, tensile strength is important for a crack, such as a tear, which occurs where the loads from both directions overlap. The load from the passenger or the side air bag is generally present in the region where the load is applied, whereas the tensile load is present along the boundary of the region where the load from the passenger or the side air bag is applied, such as the boundary of an arm rest where loads tend to concentrate. This is because the reactive force from the passenger or the side air bag serves as a kind of supporting area (fulcrum) against the impact load from the outside and causes a local and large tensile load along the boundary (see the marks “X” in FIG. 3). Therefore, it is important that the resin core have, as the mechanical property of the material, excellent impact-resistive capability, such as substantial toughness, and excellent tensile properties, such as large tensile elongation, in order to prevent cracks and sharp edges. As will be described later, damage from the tensile load is prevented by using a tape member.

In resin core 10 shown in FIG. 2, skin layer 10b that covers foam layer 10a is a hard-cured non-foam layer in the form of a thin film. Accordingly, cracks and sharp edges in resin core 10 tend to be easily generated in a side crash accident, as compared to a vehicle door trim panel in which the resin core is entirely made of a solid non-foam layer. This tendency becomes more pronounced as the expansion ratio increases. Tensile elongation can be increased by changing the material composition, for example, by adding a rubber based component to resin core 10, but this method prevents weight reduction because the rubber based component prevents foaming. This is because when molding a generally thin vehicle door trim panel (the thickness of the main portion is about 3 mm) with a large expansion ratio, for example, a ratio between 1.6 and 2.4, the resin core may be cooled before being completely foamed and, as a result, the desired expansion ratio may not be obtained. Simply relying on adjustments of material in order to achieve weight reduction by high expansion ratio foaming and in order to prevent cracks and sharp edges may require much effort and may cause a cost increase due to the use of expensive resins.

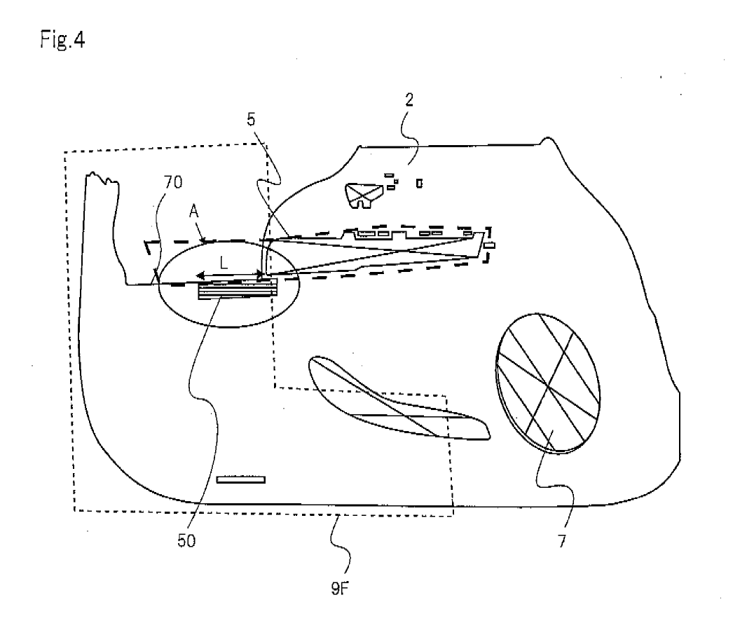

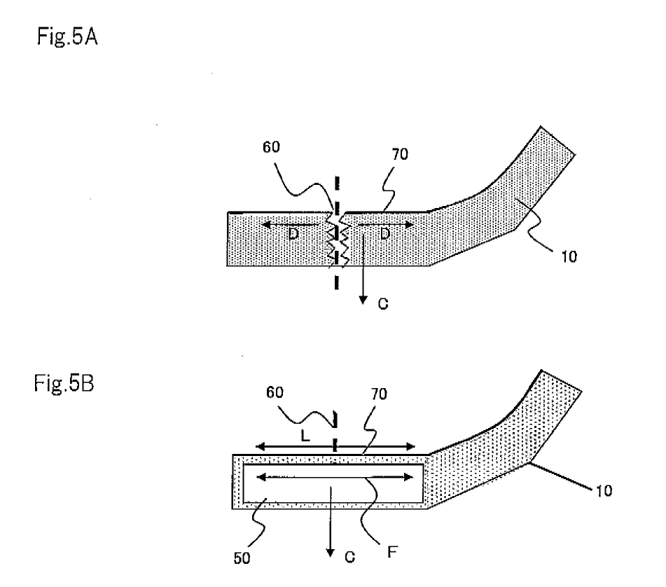

The present invention enables high expansion ratio foaming and prevention of cracks and sharp edges by the simple configuration, as shown in FIG. 4, 5A and 5B. FIG. 4 is a general schematic view of the trim lower member of the front door trim panel of FIG. 1, as viewed from outside the vehicle (the back surface of the trim lower member). FIGS. 5A and 5B are enlarged views of portion “A” in FIG. 4 showing a crack initiating point and a tape member. In FIG. 4, the apertures are indicated by the mark “X”.

In front door trim panel 1F of an embodiment of the present invention, a filament tape (tape member 50) is applied to the back surface of resin core 10 that constitutes trim lower member 2, as shown in FIG. 4. The filament tape is applied in the vicinity of outer edge 70 of resin core 10 in impact area 9F, more specifically in the vicinity of the area below ornament 4 (in the vicinity of arm rest 5) which is not shown. Tape member 50 is applied along outer edge 70 in the direction in which longitudinal direction L thereof is parallel to outer edge 70. Tape member 50 is preferably applied to the back surface of resin core 10 from the standpoint of ornamental design, but may also be applied to the front surface of resin core 10 facing the vehicle compartment. In the latter case, it is desirable to take into consideration ornamental design by, for example, limiting the locations of tape member 50 to locations where the tape can be hidden by other members.

FIG. 5A shows, as a comparative example, an enlarged view of the main part after the above-described JNCAP side impact test was conducted without applying tape member 50, and FIG. 5B shows an enlarged view of the main part (portion “A” in FIG. 4) after the JNCAP side impact test was conducted with the tape member 50 applied. As shown in FIG. 5A, in which the tape member is not applied, the above-described load from the vehicle compartment and the load from outside the vehicle are generated and applied, and as a result, cracks or sharp edges are generated in resin core 10 at crack initiating point 60 where the stress in both directions concentrates. Cracks and sharp edges tend to be generated at outer edge 70 of resin core 10 and also tend to be generated at the peripheral edge of the aperture, if resin core 10 has an aperture. The cracks and sharp edges propagate inward from crack initiating point 60.

In this embodiment, tape member 50 is applied to resin core 10 at a location where tape member 50 bridges crack initiating point 60 of resin core 10, as shown in FIG. 5B. Tape member 50 works to keep together the portions on both sides of crack initiating point 60 which would otherwise be stretched and separated in opposite directions (the directions D in FIG. 5A) from crack initiating point 60. As a result, the generation of a crack in resin core 10 can be prevented. Even if a crack is generated at outer edge 70 of resin core 10a due to stress of an unexpected magnitude, tape member 50 prevents the crack propagation halfway and effectively prevents the crack initiating point of resin core 10 from developing as a sharp edge.

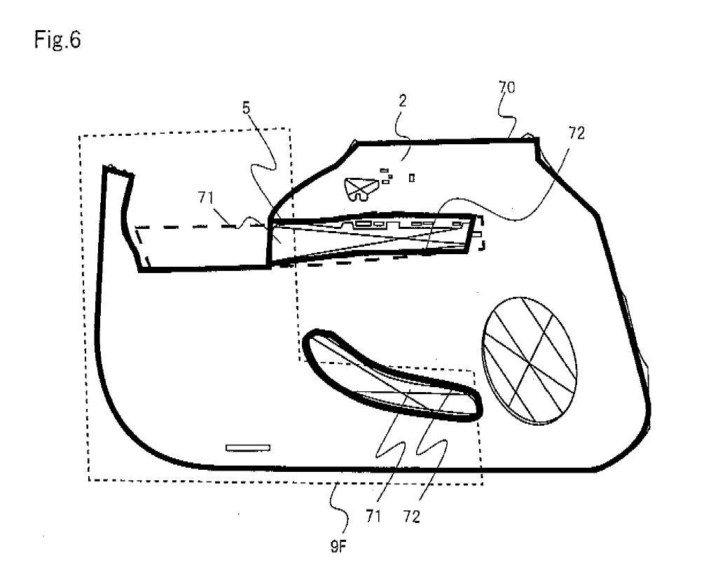

Since crack initiating points 60 are usually present at the outer edge of resin core 10 or at the peripheral edge of an aperture, as described above, tape member 50 is preferably applied at the outer edge or the peripheral edge of resin core 10. Some exemplary locations for applying tape member 50 in trim lower member 2 are shown in the bold lines in FIG. 6. Tape member 50 may be applied at any location along the entire length of the outer edge and the peripheral edges. From the standpoint of passenger protection, tape member 50 may be preferably applied in impact area 9F. However, tape member 50 may also be applied such that it bridges the boundary between impact area 9F and the non-impact area, or may only be applied in the non-impact area, or may be applied along the entire length of the outer edge and the peripheral edges.

In impact area 9F, cracks and sharp edges tend to be particularly generated in the vicinity of arm rest 5. This is because arm rest 5 protrudes toward the vehicle compartment, as shown in the large dimensions in FIG. 3. The passenger is apt to contact arm rest 5, and the load from inside of the vehicle tends to increase at contact arm rest 5. In addition, when a side air bag is mounted, the load from inside of the vehicle further increases because the side air bag usually develops in the vicinity of arm rest 5. Therefore, it is effective to apply tape member 50 along at least a part of outer edge 70 in the vicinity of the boundary of arm rest 5. In addition, a tensile load which causes a crack, such as a tear, tends to be present along the boundary of impact area 9F for the reason described above. Therefore, it is also effective to apply tape member 50 along at least a part of the area where the o boundary of impact area 9F and outer edge 70 overlap.

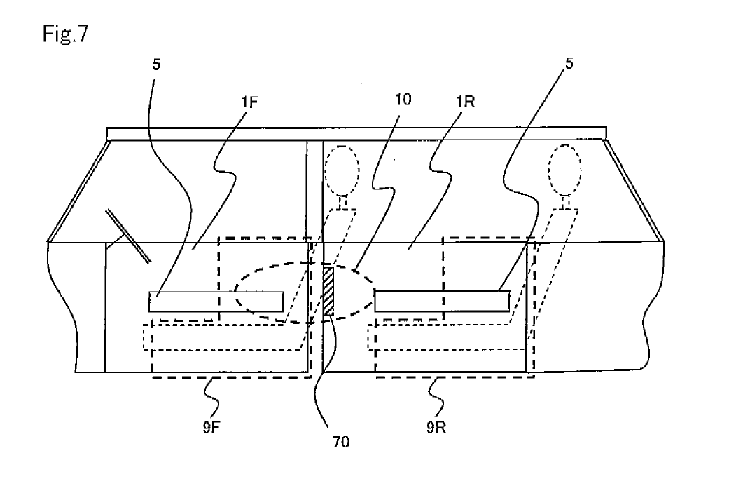

The same approach that is applied to the front door trim panel is also applied to the rear door trim panel. FIG. 7 shows the locations for applying the tape member in rear door trim panel 1R. As with the front door trim panel, tape member 50 is preferably applied along at least a part of outer edge 70 or peripheral edge 72 in impact area 9R, which is the rear half of rear door trim panel 1R, seen in the travel direction of the vehicle, and the lower half of rear door trim panel 1R. When arm rest 5 is provided, the tape member 50 may be preferably applied in the vicinity of arm rest 5, where cracks and sharp edges tend to be generated.

Side air bag 11 (see FIG. 3) is usually mounted to a seat and is caused to inflate between the seat and the vehicle door trim panel. Side air bag 11 of this type is inflated in the front-rear direction of the vehicle. Therefore, the inflated side air bag 11 for the front seat may abuts with rear door trim panel 1R at location 10 that is located on the front side of rear door trim panel 1 R, seen in the travel direction of the vehicle. Thus, cracks and sharp edges tend to be generated at location 10 in rear door trim panel 1R, although it is usually outside impact area 9R. Therefore, tape member 50 may be preferably applied at least along a part of outer edge 70 located in the vicinity of the location 10 where inflated side air bag 11 abuts with rear door trim panel 1R.

Tape member 50 preferably has a tensile strength of not less than 200 N/cm and an adhesive force of not less than 4.0 N/cm. With such tensile strength and adhesive force, breakage and exfoliation of tape member 50 can be prevented regardless of the shape of the tape applying locations on a vehicle door trim panel, which is not always planar but may often be three-dimensional. As a result, cracks and sharp edges in resin core 10 can be prevented from occurring more effectively when an impact load is applied in a side crash accident of the vehicle. Tape member 50 may be preferably a filament tape in which a film base material made of polypropylene or polyester is reinforced with high-strength fibers, such as glass fibers. The fibers are preferably arranged in direction F that is substantially perpendicular to propagation direction C of a crack (the direction substantially perpendicular to the outer edge or the peripheral edge), as shown in FIG. 5B. Two or more superposed layers of tape members 50 may also be applicable when the tensile strength is not sufficient.

As described above, the tape member in the present invention improves the mechanical properties, especially tensile property, of the vehicle door trim panel to a desirable level which can not be achieved simply by selecting and adjusting the material. Thus, it is possible, with a simple and inexpensive configuration, to achieve weight reduction by high expansion ratio foaming, while ensuring safety performance by preventing cracks and sharp edges from occurring,

The preferable locations for applying the tape member depend on the type of the vehicle and on the configuration of the vehicle door trim panel. Therefore, side impact testing may be preferably used simultaneously for further optimization of locations where the tape member is applied. Side impact testing may be conducted according to the above-described JNCAP side impact test. However, a test that simulates the JNCAP side impact test may also be applied to each part. Specifically, a jig is attached to a vehicle door trim panel on the surface that is to be on the inner side of the vehicle door trim panel when incorporated in the door panel. The location of the jig corresponds to the location of dummy 20 in the JNCAP side impact test. The vehicle door trim panel is held in this way. In this state, an impact load is applied from a side that is to be outside the vehicle in order to identify cracks or sharp edges that are generated at the outer edge of the resin core or at the peripheral edge of an aperture due to the impact load. The locations where cracks or sharp edges are easily generated can thus be identified in details for each vehicle type and for each vehicle door trim panel based on the test results. Next, a vehicle door trim panel for product use is fabricated, and tape members are applied along the outer edge or the peripheral edge at the locations where the cracks or the sharp edges were generated in the test.

By applying the tape member and manufacturing the vehicle door trim panel according to these steps, it is possible to prevent the occurrence of cracks and sharp edges in the resin core without incurring an extra cost in an effective manner suited to the actual condition of a side crash accident.

Although certain preferred embodiments of the present invention have been shown and described in detail, it should be understood that various changes and modifications may be made without departing from the spirit or scope of the appended claims.

What is claimed is:

1. A vehicle door trim panel comprising a resin core, the resin core comprising a foam layer and a skin layer that covers the foam layer, the skin layer being harder and thinner than the foam layer,
wherein a tape member is applied to the resin core along at least a part of an outer edge of the resin core or along at least a part of a peripheral edge of an aperture of the resin core.

2. The door trim panel according to claim 1, wherein the part of the outer edge and the part of the peripheral edge are located in a rear half of the vehicle door trim panel, seen in a travel direction of the vehicle, or in a lower half of the vehicle door trim panel.

3. The door trim panel according to claim 2, wherein the tape member is applied to the resin core at a boundary of an impact area or in a vicinity of an arm rest, the impact area being subject to a load from a passenger.

4. The door trim panel according to claim 1, the vehicle door trim panel being adapted to be associated with a side air bag, wherein the tape member is applied to the resin core along a part of the outer edge of the resin core, the part of the outer edge being located in a vicinity of an area where the side air bag abuts with the vehicle door trim panel when inflated.

5. The door trim panel according to claim 1, wherein the resin core has an expansion ratio that is not less than 1.6 and not more than 2.4.

6. The door trim panel according to claim 1, wherein the tape member is a filament tape in which a film base material is reinforced with fibers.

7. The door trim panel according to claim 1, wherein the tape member has a tensile strength that is not less than 200 N/cm and an adhesive force that is not less than 4.0 N/cm.

8. A method for manufacturing a vehicle door trim panel, comprising the steps of:
applying an impact load to a vehicle door trim panel from an outside of a vehicle, while holding the vehicle door trim panel from an inside of the vehicle, wherein the vehicle door trim panel comprises a resin core, the resin core comprises a foam layer and a skin layer that covers the foam layer, the skin layer being harder and thinner than the foam layer;
identifying a crack or a sharp edge that is generated, due to the impact load, at an outer edge of the resin core or at a peripheral edge of an aperture of the resin core; and
fabricating another vehicle door trim panel having the same construction as the vehicle door trim panel, and applying a tape member at a location where the crack or the sharp edge is generated, the tape member being applied along the outer edge or the peripheral edge.
